(19) United States
(12) Patent Application Publication
(10) Pub. No.: US 2026/0299611 A1
(43) Pub. Date: Oct. 1, 2026

(54) CONTROL DEVICE, CONTROL METHOD, AND PROGRAM

(71) Applicant: HONDA MOTOR CO., LTD., Minato-ku, Tokyo (JP)

(72) Inventors: Sango Matsuzaki, Wako-shi (JP); Misa Komuro, Wako-shi (JP)

(21) Appl. No.: 19/163,399

(22) PCT Filed: Mar. 17, 2023
(86) PCT No.: PCT/JP2023/010663

§ 371 Date: Sep. 9, 2025

(51) Int. Cl. G05D 1/686; G05D 105/30; G05D 107/60; G05D 109/10; G05D 111/10

(52) U.S. Cl. CPC G05D 1/686; G05D 2105/315; G05D 2107/67; G05D 2109/10; G05D 2111/10

(57) ABSTRACT

A control device of a mobile object that at least temporarily leads a user includes an information acquisition unit configured to acquire information on a movement direction of the user, a region setting unit configured to set a predetermined region based on the mobile object, a target position determination unit configured to determine a target position to which the mobile object will move on the basis of the movement direction and the predetermined region, and a traveling control unit configured to control a driving device attached to the mobile object so that the mobile object moves to the target position.

### TECHNICAL FIELD

The present invention relates to a control device, a control method, and a program.

### BACKGROUND ART

In recent years, mobile objects (called robots, micromobilities, and the like) that move autonomously while following a user for the purpose of transporting luggage of a user, or the like have been put into practical use. For example, Patent Document 1 discloses a technology for determining a path of an autonomous mobile device for moving parallel to a target to be followed when a sign of a change in the path of the target to be followed is detected.

### CITATION LIST

### Patent Document

Patent Document 1: Japanese Unexamined Patent Application, First Publication No. 2020-201570

### SUMMARY OF INVENTION

### Technical Problem

The technology described in Patent Document 1 relates to control of a mobile object to move parallel to a target to be followed. However, the conventional technology did not consider controlling a mobile object to lead a user such as a pedestrian (that is, to take into account the movement direction of the user and to travel ahead in the movement direction).

The present invention has been made in consideration of circumstances described above, and one of its objectives is to provide a control device, a control method, and a program that can appropriately control a mobile object to lead the user.

### Solution to Problem

A vehicle control device according to the present invention has adopted the following configuration.
(1): A mobile object control device according to one aspect of the present invention is a control device of a mobile object that at least temporarily leads a user and includes an information acquisition unit configured to acquire information on a movement direction of the user, a region setting unit configured to set a predetermined region based on the mobile object, and a target position determination unit configured to determine a target position to which the mobile object will move on the basis of the movement direction and the predetermined region.
(2): In the aspect of (1) described above, the predetermined region may be a circle or an ellipse.
(3): In the aspect of (1) described above, the target position determination unit may determine an intersection point between a straight line passing through the user and aligned along the movement direction and the predetermined region as the target position.
(4): In the aspect of (3) described above, the target position determination unit may determine, when there are a plurality of intersection points between the straight line and the predetermined region, an intersection point in the movement direction that is farthest from the user as the target position.
(5): In the aspect of (3) described above, when there is no intersection point between the straight line and the predetermined region, the target position determination unit may determine a foot of a perpendicular line from the mobile object to the straight line as the target position.
(6): In the aspect of (1) described above, when the traveling control unit causes the mobile object to move to the target position, the information acquisition unit may re-acquire information on the movement direction of the user, the region setting unit may reset a predetermined region based on the mobile object that has moved to the target position, and the target position determination unit may re-determine a target position to which the mobile object will move on the basis of the reacquired movement direction and the reset predetermined region.
(7): In the aspect of (1) described above, the region setting unit may change a parameter that defines the predetermined region in accordance with an appearance or a moving speed of the user.
(8): In the aspect of (1) described above, the region setting unit may change a parameter that defines the predetermined region in accordance with an input by the user.
(9): In the aspect of (1) described above, the region setting unit may change a parameter that defines the predetermined region in accordance with a degree of proximity of the user to the mobile object.
(10): In the aspect of (1) described above, the region setting unit may change a parameter that defines the predetermined region in accordance with a degree of congestion of a traveling environment in which the mobile object is traveling.
(11): A mobile object control method according to another aspect of the present invention includes, by a control device of a mobile object that at least temporarily leads a user, acquiring information on a movement direction of the user, setting a predetermined region based on the mobile object, determining a target position to which the mobile object will move on the basis of the movement direction and the predetermined region, and controlling a driving device attached to the mobile object so that the mobile object moves to the target position.
(12): A program according to still another aspect of the present invention causes a control device of a mobile object that at least temporarily leads a user to execute acquiring information on a movement direction of the user, setting a predetermined region based on the mobile object, determining a target position to which the mobile object will move on the basis of the movement direction and the predetermined region, and controlling a driving device attached to the mobile object so that the mobile object moves to the target position.

### Advantageous Effects of Invention

According to the aspects of (1) to (12) described above, it is possible to appropriately control a mobile object to lead a user.

According to the aspect of (6) described above, even if the mobile object is positioned behind the user, the mobile object can transition to leading of the user by repeatedly executing predetermined processing.

### BRIEF DESCRIPTION OF DRAWINGS

FIG. 1 A diagram representing an example of a mobile object M including a control device 100 according to an embodiment.

FIG. 2 A diagram representing an example of functional constituents of the mobile object M.

FIG. 3 A diagram representing an example of a screen displayed by an HMI 30.

FIG. 4 A diagram for describing a method of discretizing a movement direction of a user U.

FIG. 5 A diagram representing an example of a predetermined region R set by a region setting unit 120.

FIG. 6 A diagram representing an example of another situation in which the predetermined region R is set by the region setting unit 120.

FIG. 7 A diagram representing an example of another situation in which the predetermined region R is set by the region setting unit 120.

FIG. 8 A diagram representing an example of another situation in which the predetermined region R is set by the region setting unit 120.

FIG. 9 A flowchart representing an example of a flow of processing executed by a control device 100.

### DESCRIPTION OF EMBODIMENTS

Hereinafter, an embodiment of a control device, a control method, and a program of the present invention will be described with reference to the drawings.

### Overall Configuration

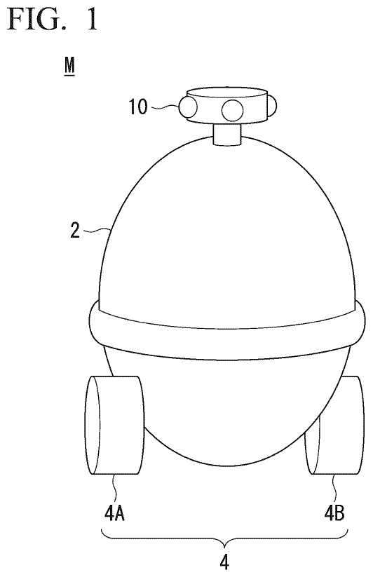

FIG. 1 is a diagram which shows an example of a mobile object M equipped with a control device according to an embodiment. The mobile object M is an autonomous mobile robot. The mobile object M supports a behavior of a user U. For example, the mobile object M stops at a position specified by the user U and guides the user U to the destination after receiving an input of a destination, or leads the user U (that is, travels ahead of the user U in a movement direction of the user U) on the basis of information on the movement direction of the user U without receiving an input of the destination. In this manner, in the present embodiment, it is described that the mobile object M guides or leads the user U as a pedestrian, but the mobile object M may be a vehicle on which the user U can ride, and in that case, may move to the destination with the user U on board after receiving an input of the destination by the user U.

The mobile object M includes, for example, a main body 2, one or more wheels 4 (4A and 4B in FIG. 1), and a camera 10. For example, the mobile object M recognizes a free space in which the mobile object M can travel on the basis of an image captured by the camera 10, and drives the wheels 4 so that they travel in the recognized free space to guide or lead the user U.

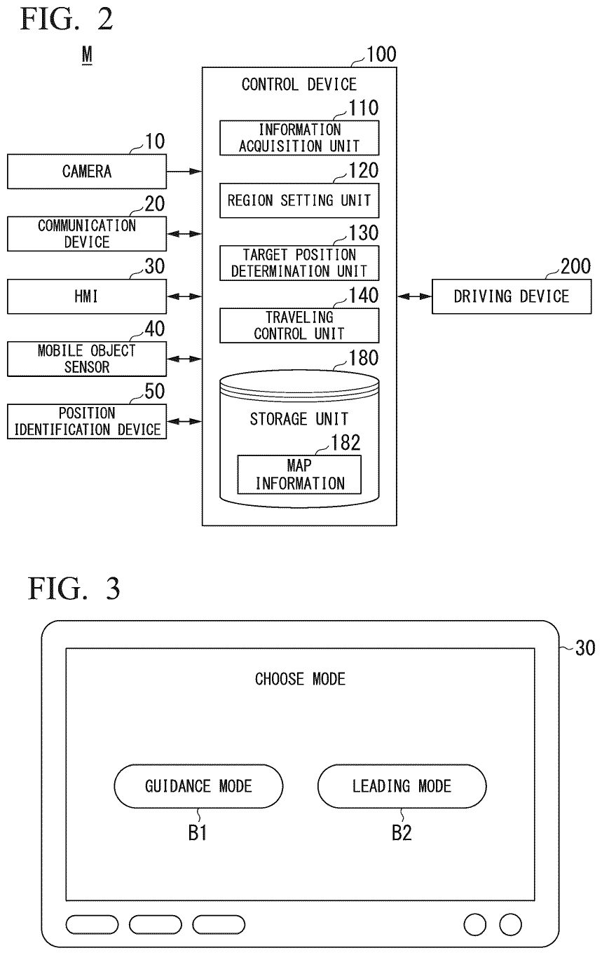

FIG. 2 is a diagram which shows an example of functional constituents of the mobile object M. The mobile object M includes, for example, a camera 10, a communication device 20, an HMI 30, a mobile object sensor 40, a position identification device 50, a control device 100, and a driving device 200.

The camera 10 captures images of a periphery of the mobile object M. The camera 10 is, for example, a fisheye camera capable of capturing images of the periphery of the mobile object M at a wide angle (for example, 360 degrees). The camera 10 is, for example, attached to a top of the mobile object M, and captures images of the periphery of the mobile object M at a wide angle in a horizontal direction. The camera 10 may be realized by combining a plurality of cameras (a plurality of cameras capturing images in a range of 120 degrees or 60 degrees in the horizontal direction). In addition to the camera 10, the mobile object M may be equipped with a radar device or LIDAR for detecting an object.

The communication device 20 is a communication interface for communicating with other devices using a cellular network, a Wi-Fi network, Bluetooth (registered trademark), DSRC (Dedicated Short Range Communication), or the like.

The HMI 30 presents various types of information to the user U of the mobile object M and receives an input operation by the user U. The HMI 30 includes various types of display devices, speakers, buzzers, touch panels, switches, keys, and the like attached to the mobile object M. Alternatively, functions of the HMI 30 may be mounted as an application program in a mobile terminal of the user U of the mobile object M. In this case, the mobile object M may present various types of information to the user U via the mobile terminal and receive an input operation by the user U.

FIG. 3 is a diagram which shows an example of a screen displayed by the HMI 30. As shown in FIG. 3, the HMI 30 displays, for example, a button B1 for causing the mobile object M to guide the user U, and a button B2 for causing the mobile object M to lead the user U. When the user U presses the button B1, the control device 100 sets the mobile object M to a guidance mode. More specifically, for example, the control device 100 displays an input field on the HMI 30 for inputting a destination, and upon receiving an input of a destination by the user U, identifies the destination by searching the map information 182 stored in the storage unit 180, and causes the mobile object M to travel from a current position identified by the position identification device 50 described below to the destination.

On the other hand, when the user U presses the button B2, the control device 100 sets the mobile object M to a leading mode. More specifically, for example, the control device 100 acquires information on the movement direction of the user U by a method described below, and leads the user U in the acquired movement direction. At this time, it should be noted that in leading, unlike guidance, a destination is not set. Leading is executed when the user U travels around a section such as a store or a shopping mall without clearly determining a destination. The HMI 30 may be able to adjust a moving speed of the mobile object M in leading by receiving an input of a parameter that defines a predetermined region R which will be described below. The mobile object M can lead the user U in a crowded area such as a store or shopping mall, thereby helping the user U, such as a person with poor mobility, to move comfortably through the area. In this manner, in the present embodiment, the control device 100 allows the user U to switch between the leading mode and the guidance mode of the mobile object M via the HMI 30. In this manner, the mobile object M according to the present embodiment can satisfy a wide variety of needs regarding the movement of the user U with a single housing.

The mobile object sensor 40 includes a vehicle speed sensor that detects a speed of the mobile object M, an acceleration sensor that detects the acceleration, a yaw rate sensor that detects the angular speed around the vertical axis, and a direction sensor that detects a direction of the mobile object M.

The position identification device 50 identifies a position of the mobile object M on the basis of signals received from GNSS satellites. The position of the mobile object M may be identified or supplemented by an inertial navigation system (INS) that uses an output of the mobile object sensor 40.

The control device 100 includes, for example, an information acquisition unit 110, a region setting unit 120, a target position determination unit 130, a traveling control unit 140, and a storage unit 180. The information acquisition unit 110, the region setting unit 120, the target position determination unit 130, and the traveling control unit 140 are each realized by, for example, a hardware processor such as a central processing unit (CPU) executing a program (software). In addition, some or all of these components may be realized by hardware (a circuit unit; including circuitry) such as large scale integration (LSI), an application specific integrated circuit (ASIC), a field-programmable gate array (FPGA), or a graphics processing unit (GPU), or may be realized by software and hardware in cooperation. The program may be stored in a storage unit 180 (a storage device having a non-transient storage medium) such as a HDD or flash memory, or may be stored in a removable storage medium such as a DVD or CD-ROM, and may be installed in the HDD or flash memory by attaching the storage medium (non-transient storage medium) to a drive device. Some of the functional units described above may be included in other devices.

The information acquisition unit 110 acquires information on the movement direction of the user U. More specifically, for example, the information acquisition unit 110 may acquire images including the user U captured by the camera 10 in a time series, and detect the movement direction of the user U on the basis of a positional change of the user U in the time series images. In addition, for example, the information acquisition unit 110 may detect key points (for example, eyes, nose, mouth, joints) of a body of the user U from a single image including the user U captured by the camera 10, and detect a direction of the detected key points as the movement direction of the user U. Moreover, for example, the information acquisition unit 110 may detect the movement direction of the user U by inputting an image into a learned model that has been learned to output the movement direction of a person when an image including the person is input.

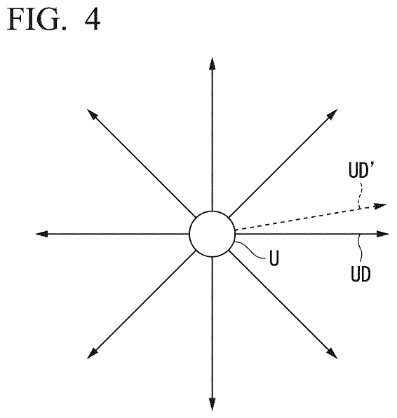

When the information acquisition unit 110 detects the movement direction of the user U, it may acquire the movement direction to be used in subsequent processing by discretizing the detected movement direction. FIG. 4 is a diagram for describing a method of discretizing the movement direction of the user U. As shown in FIG. 4, the information acquisition unit 110 may set, for example, candidates for a plurality of movement directions (eight in FIG. 4) based on the mobile object M, and acquire a candidate for a movement direction that forms a smallest angle with a detected movement direction UD′ of the user U as a movement direction UD. As a result, it is possible to reduce a processing load on the control device 100.

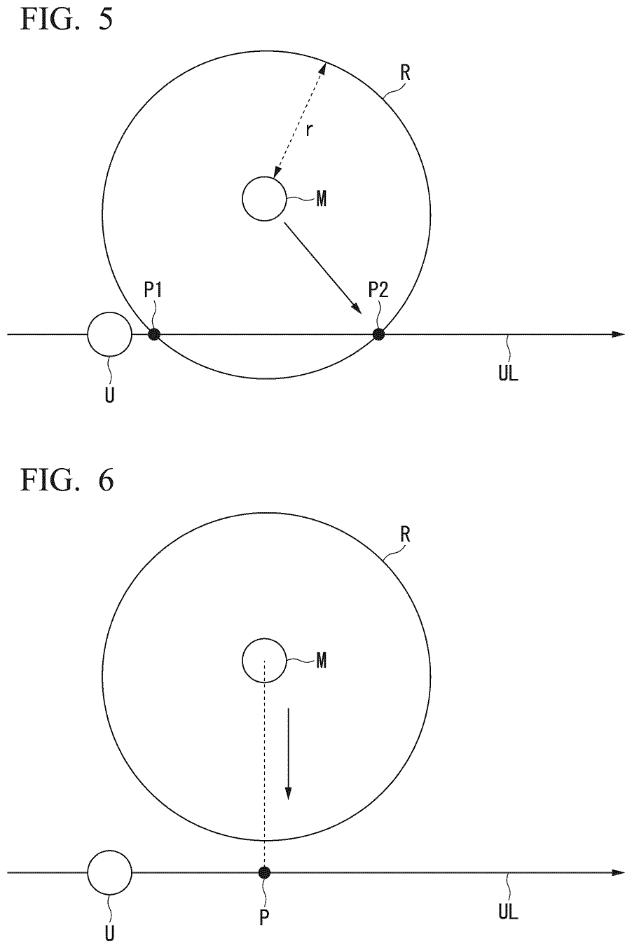

The region setting unit 120 converts the image including the user U captured by the camera 10 into a bird's-eye view coordinate system, and sets a predetermined region R in the bird's-eye view coordinate system with the mobile object M as a reference (for example, a center). FIG. 5 is a diagram which shows an example of the predetermined region R set by the region setting unit 120. FIG. 5 shows an image obtained by converting the image including the user U captured by the camera 10 into the bird's-eye view coordinate system. In FIG. 5, a symbol UL represents a straight line along the movement direction of the user U acquired by the information acquisition unit 110. As shown in FIG. 5, for example, the region setting unit 120 sets a circle with a radius r centered on the mobile object M as the predetermined region R. The radius r is an example of a “parameter that defines the predetermined region” in the claims. The predetermined region R is not limited to a circle, and may be any region with any shape and area that includes at least the mobile object M, such as an ellipse.

The target position determination unit 130 determines a target position to which the mobile object M will move, on the basis of the straight line UL along the movement direction of the user U and the predetermined region R set by the region setting unit 120. More specifically, the target position determination unit 130 determines, among intersection points P1 and P2 between the straight line UL and the predetermined region R, an intersection point P2 which is the farthest from the user U in the movement direction of the user U as the target position. When the straight line UL and the predetermined region R are in contact, the target position determination unit 130 determines a point of contact as the target position.

The traveling control unit 140 controls the driving device 200 so that the mobile object M moves to the target position determined by the target position determination unit 130. The driving device 200 includes, for example, a motor that drives drive wheels, a battery that stores power supplied to the motor, a steering device that adjusts a steering angle of steering wheels, and an electronic control unit (ECU) that controls these components. The ECU controls the components described above according to information input from the traveling control unit 140. The driving device 200 may include an internal combustion engine or a fuel cell as a driving force output means or a power generation means. In addition, the driving device 200 may further include a brake device that uses frictional force or air resistance.

With the configuration described above, the control device 100 acquires information on the movement direction of the user U on the basis of an image including the user U captured by the camera 10, and controls the mobile object M to lead the user U in consideration of the movement direction of the user U. That is, according to the present embodiment, the mobile object M can be appropriately controlled to lead the user.

### Other Situation Related to Region Setting

In FIG. 5, a situation is described in which the straight line UL along the movement direction of the user U and the predetermined region R set by the region setting unit 120 have one or more intersection points (at least being in contact). However, for example, when a distance between the user U and the mobile object M is large, the straight line UL and the predetermined region R do not necessarily have an intersection point. In addition, for example, even if the straight line UL and the predetermined region R have one or more intersection points, the intersection points are not necessarily present in front of the user U in the traveling direction. Hereinafter, an operation of the region setting unit 120 in a situation different from the situation shown in FIG. 5 will be described.

FIG. 6 is a diagram which shows an example of another situation in which the predetermined region R is set by the region setting unit 120. FIG. 6 represents a situation in which the predetermined region R set by the region setting unit 120 does not have an intersection point with the straight line UL. When the predetermined region R set by the region setting unit 120 does not have an intersection point with the straight line UL, the region setting unit 120 draws a perpendicular line from the mobile object M to the straight line UL and determines an intersection point of the perpendicular line and the straight line UL (that is, a foot of the perpendicular line) as a target position P. In other words, when the set predetermined region R does not have an intersection point with the straight line UL, the region setting unit 120 increases a value of the radius r until the predetermined region R comes in contact with the straight line UL, and determines the obtained point of contact as the target position P.

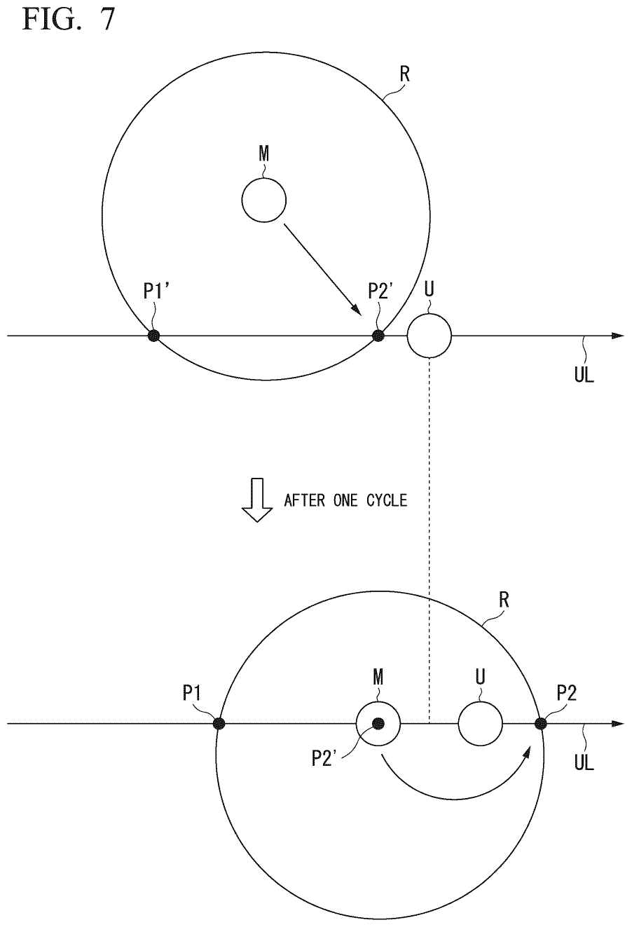

FIG. 7 is a diagram which shows an example of another situation in which the predetermined region R is set by the region setting unit 120. FIG. 7 represents a situation in which the predetermined region R set by the region setting unit 120 has two intersection points P1′ and P2′ with the straight line UL, but neither of the intersection points is present in the traveling direction of the mobile object M. At this time, as shown in an upper part of FIG. 7, the target position determination unit 130 first determines the intersection point P2′, which is closer to the mobile object M, as the target position, and the traveling control unit 140 causes the mobile object M to travel to the determined target position P2′.

After that, when the mobile object M reaches the target position P2′, the region setting unit 120 again sets a predetermined region R with the mobile object M as a reference for a next cycle of operations, and the target position determination unit 130 obtains intersection points P1 and P2 with the straight line UL. At this time, depending on a moving speed of the user U, as shown in a lower part of FIG. 7, the obtained intersection point P2 is in the movement direction of the user U. For this reason, the target position determination unit 130 determines the intersection point P2 as a target position of the mobile object M, and the traveling control unit 140 causes the mobile object M to travel to the determined target position P2. In other words, according to the present embodiment, even if the mobile object M is positioned behind the user U in the movement direction, the mobile object M can return to leading of the user U by the control device 100 repeating a control cycle.

In order for the mobile object M positioned behind the user U to reliably catch up with the user U and return to the leading, the traveling control unit 140 may control the traveling of the mobile object M so that a traveling speed of the mobile object M always exceeds the moving speed of the user U while the mobile object M is positioned behind the user U. When the control device 100 repeats the control cycle described above while the traveling speed of the mobile object M always exceeds the moving speed of the user U, the mobile object M can reliably return to the leading of the user U. As another method, when an intersection point between the set predetermined region R and the straight line UL is not present in the movement direction of the user U, the region setting unit 120 may increase a value of the radius r until the intersection point is positioned in the movement direction of the user U, and determine the intersection point obtained in the movement direction of the user U as the target position P.

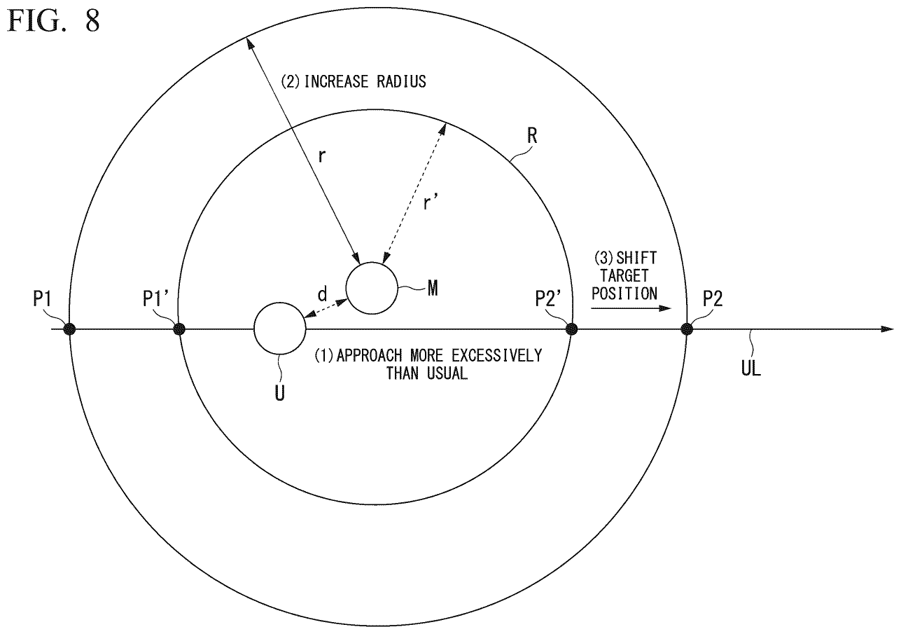

FIG. 8 is a diagram which shows an example of another situation in which the region setting unit 120 sets the predetermined region R. While leading the user U, the control device 100 measures an average distance between the user U and the mobile object M, and when a distance d between the user U and the mobile object M significantly deviates from the average distance, the control device 100 may adjust a distance traveled by the mobile object M per unit time (that is, the moving speed) by changing the value of the radius r. The distance d is an example of the “degree of proximity” in the claims.

For example, as shown in FIG. 8, when the distance d between the user U and the mobile object M becomes significantly smaller than the average distance (that is, when an interval between the average distance and the distance d is equal to or greater than a threshold value), the region setting unit 120 increases the value of the radius r, and the target position determination unit 130 shifts the target position P2′ to the target position P2. As a result, the mobile object M is controlled to travel a longer distance in the same control cycle, and as a result, the moving speed of mobile object M increases. As a result, assuming that the moving speed of the user U is the same, the mobile object M will move away from the user U, and a comfortable distance for the user U can be maintained.

Similarly, when the distance d between the user U and the mobile object M becomes significantly larger than the average distance (that is, when the interval between the distance d and the average distance is equal to or greater than the threshold value), the region setting unit 120 decreases the value of the radius r, and the target position determination unit 130 shifts the target position P2 to the target position P2′. As a result, the mobile object M is controlled to travel a shorter distance in the same control cycle, and as a result, the moving speed of the mobile object M decreases. As a result, assuming that the moving speed of the user U is the same, the mobile object M will move closer to the user U, and a comfortable distance for the user U can be maintained. In addition, even if the user U increases or decreases the moving speed because he or she wishes to change the comfortable distance between the user U and the mobile object M, this increase or decrease is reflected in the average distance measured by the control device 100, so that this control can maintain a comfortable distance for the user U.

In another configuration, the region setting unit 120 may change the value of the radius r according to an appearance or the moving speed of the user U. For example, the region setting unit 120 may calculate an index value related to walking ability of the user U, such as an age or fatigue level, on the basis of an image including the user U captured by the camera 10, and set the value of the radius r to a smaller value to decrease the moving speed of the mobile object M as the calculated index value becomes lower. In addition, the region setting unit 120 may set the value of the radius r to a higher (lower) value to increase (decrease) the moving speed of the mobile object M as the measured moving speed of the user U becomes higher (lower). As a result, it is possible to prevent the user U from feeling uncomfortable due to the deviation of the moving speed of the mobile object M from his or her own moving speed.

As another configuration, the region setting unit 120 may change the value of the radius r according to a degree of congestion of a traveling environment in which the mobile object M is traveling. For example, when the image captured by the camera 10 includes a predetermined number or more of persons or obstacles other than the user U, the region setting unit 120 may set the value of the radius r to a small value and decrease the moving speed of the mobile object M. As a result, it is possible to reduce a risk of other pedestrians cutting in between the user U and the mobile object M, or a risk of the mobile object M coming into contact with other pedestrians.

Similarly, when the image captured by the camera 10 includes less than a predetermined number of persons or obstacles other than the user U, the region setting unit 120 may set the value of the radius r to a large value and increase the moving speed of the mobile object M. As a result, the user U can comfortably move in a section with a large free space.

### Control Flow

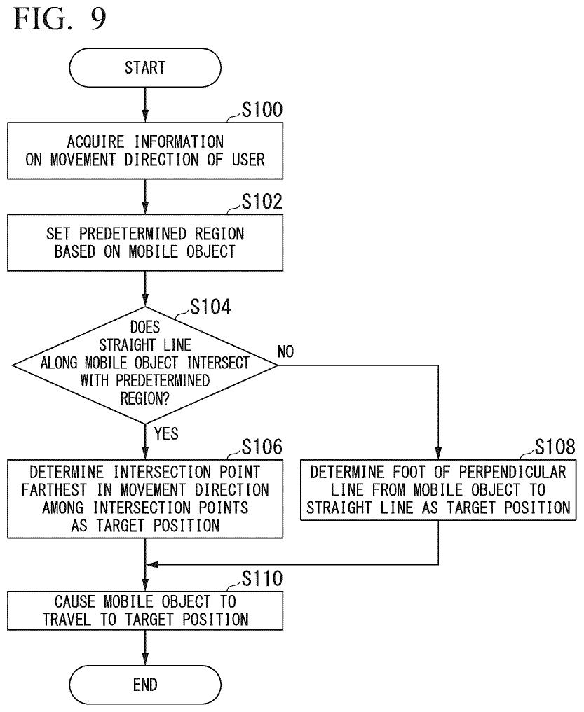

Next, referring to FIG. 9, a flow of processing executed by the control device 100 will be described. FIG. 9 is a flowchart which shows an example of the flow of processing executed by the control device 100. Processing of the flowchart shown in FIG. 9 is executed, for example, when the user U sets the leading mode on the HMI 30.

First, the information acquisition unit 110 acquires information on the movement direction of the user U (step S100). Next, the region setting unit 120 sets a predetermined region R based on the mobile object M (step S102). Next, the target position determination unit 130 determines whether a straight line UL along the movement direction of the user U intersects with the predetermined region R (step S104).

When it is determined that the straight line UL intersects with the predetermined region R, the target position determination unit 130 determines an intersection point farthest from the user U in the movement direction of the user U as the target position (step S106). On the other hand, when it is determined that the straight line UL does not intersect with the predetermined region R, the target position determination unit 130 determines the foot of the perpendicular line from the mobile object M to the straight line UL as the target position (step S108). Next, the traveling control unit 140 causes the mobile object M to travel to the determined target position (step S110). As a result, the processing of this flowchart will end.

In this embodiment, an example has been described in which the guidance mode and the leading mode are set to be switchable for the mobile object M, and the control device 100 constantly executes leading of the mobile object M while the guidance mode is set for the mobile object M. However, the present invention is not limited to such a configuration, and the present invention can be applied to cases where the mobile object M at least temporarily leads the user. For example, when the mobile object M travels alongside the user or follows the user and detects a predetermined situation (for example, a presence of an obstacle or a congestion of a traffic condition) in a traveling direction of the user, the mobile object M may temporarily lead the user by executing an algorithm of the present invention.

According to the present embodiment described above, the control device acquires information on the movement direction of the user, sets a predetermined region based on the mobile object, determines a target position to which the mobile object will move on the basis of the movement direction and the predetermined region, and causes the mobile object to travel to the target position. As a result, it is possible to appropriately control the mobile object so that it leads the user.

The embodiment described above can be expressed as follows.

A mobile object control device that leads a user is configured to include a storage medium that stores computer-readable instructions, and a processor connected to the storage medium, in which the processor executes the computer-readable instructions to acquire information on a movement direction of the user, set a predetermined region based on the mobile object, determine a target position to which the mobile object will move on the basis of the movement direction and the predetermined region, and control a driving device attached to the mobile object so that the mobile object moves to the target position.

The above describes a form for carrying out the present invention using an embodiment, but the present invention is not limited to such an embodiment, and various modifications and substitutions can be made within a range that does not deviate from the gist of the present invention.

### REFERENCE SIGNS LIST

10 Camera
100 Control device
110 Information acquisition unit
120 Region setting unit
130 Target position determination unit
140 Traveling control unit

What is claim is:

1.-12 (canceled)

13. A control device of a mobile object that at least temporarily leads a user, comprising:
an information acquisition unit configured to acquire information on a movement direction of the user;
a region setting unit configured to set a predetermined region based on the mobile object;
a target position determination unit configured to determine a target position to which the mobile object will move on the basis of the movement direction and the predetermined region; and
a traveling control unit configured to control a driving device attached to the mobile object so that the mobile object moves to the target position.

14. The control device according to claim 13,
wherein the predetermined region is a circle or an ellipse.

15. The control device according to claim 13,
wherein the target position determination unit determines an intersection point between a straight line passing through the user and aligned along the movement direction and the predetermined region as the target position.

16. The control device according to claim 15,
wherein the target position determination unit determines, when there are a plurality of intersection points between the straight line and the predetermined region, an intersection point in the movement direction that is farthest from the user as the target position.

17. The control device according to claim 15,
wherein, when there is no intersection point between the straight line and the predetermined region, the target position determination unit determines a foot of a perpendicular line from the mobile object to the straight line as the target position.

18. The control device according to claim 13,
wherein, when the traveling control unit causes the mobile object to move to the target position, the information acquisition unit re-acquires information on the movement direction of the user, the region setting unit resets a predetermined region based on the mobile object that has moved to the target position, and the target position determination unit re-determines a target position to which the mobile object will move on the basis of the reacquired movement direction and the reset predetermined region.

19. The control device according to claim 13,
wherein the region setting unit changes a parameter that defines the predetermined region in accordance with an appearance or a moving speed of the user.

20. The control device according to claim 13,
wherein the region setting unit changes a parameter that defines the predetermined region in accordance with an input by the user.

21. The control device according to claim 13,
wherein the region setting unit changes a parameter that defines the predetermined region in accordance with a degree of proximity of the user to the mobile object.

22. The control device according to claim 13,
wherein the region setting unit changes a parameter that defines the predetermined region in accordance with a degree of congestion of a traveling environment in which the mobile object is traveling.

23. A control method comprising:
by a control device of a mobile object that at least temporarily leads a user,
acquiring information on a movement direction of the user;
setting a predetermined region based on the mobile object;
determining a target position to which the mobile object will move on the basis of the movement direction and the predetermined region, and
controlling a driving device attached to the mobile object so that the mobile object moves to the target position.

24. A non-transitory computer-readable storage medium having stored thereon a program causing a control device of a mobile object that at least temporarily leads a user to execute:
acquiring information on a movement direction of the user,
setting a predetermined region based on the mobile object,
determining a target position to which the mobile object will move on the basis of the movement direction and the predetermined region, and
controlling a driving device attached to the mobile object so that the mobile object moves to the target position.
